(19) United States
(12) Patent Application Publication
(10) Pub. No.: US 2006/0267522 A1
(43) Pub. Date: Nov. 30, 2006

(54) Electronic device

(75) Inventors: Chao-Ping Lee, Taipei City (TW); Chih-Ming Chen, Taipei County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/433,706

(22) Filed: May 12, 2006

(30) Foreign Application Priority Data
May 13, 2005 (TW) TW94115532

(51) Int. Cl. H05B 39/04

(52) U.S. Cl. 315/309

(57) ABSTRACT

An electronic device comprises a conductive device having a first end and a second end, a first element and a second element. The first element disposed on the first end of the conductive device generates a first temperature. The second element disposed around to the second end of the conductive device is switchable between a standby mode and an operation mode. The first temperature conducted from the first end to the second end shortens a warm-up time for the second element transferring from the standby mode to the operation mode.

### BACKGROUND

The invention relates to an electronic device, and in particular to an electronic device using a conductive device to transmit heat in order to maintain a second element substantially at a thermal level.

In FIG. 1, a heat source K1 such as CPU is disposed on a motherboard (not shown) and a conventional heat dissipation device K2 such as a fin structure is disposed on the heat source K1, so that heat from the heat source K1 is expelled to exterior via the heat dissipation device K2.

In FIG. 2, a conventional light tube L wound around a thermocouple wire W is connected to two sockets J1 and J2. When the light tube L is heated and maintained above a predetermined temperature, it is easily excited by a power supply (not shown) via the sockets J1 and J2 to emit light. Besides, the brightness of the light tube L can be stabilized when it is kept above the predetermined temperature.

Heat dissipated to the exterior in FIG. 1 is, however, wasteful and the thermo-couple wire W in FIG. 2 is an additional device maintaining the light tube L substantially at a constant temperature.

### SUMMARY

The invention provides an electronic device using a conductive device to transmit heat in order to keep a second element substantially at a thermal level. To achieve the described purpose, the invention provides an electronic device comprising a conductive device, a first element and a second element. The conductive device comprises a first end and a second end. The first element disposed on the first end of the conductive device generates a first temperature. The second element disposed around to the second end of the conductive device is switchable between a standby mode and an operation mode. When the first temperature is transmitted from the first end of the conductive device to the second end of the conductive device, the period from the standby mode to the operation mode can be shortened.

The first element can be a chip, the second element can be a light tube, and the second element can be a cold-cathode fluorescent lamp (abbreviated as CCFL). The conductive device is made of a thermal conductive material. The electronic device further comprises an intermediary disposed between the first element and the conductive device, so that the first temperature is transmitted from the intermediary to the conductive device. The intermediary can be a cooling paste or a dissipation fin. The second end of the conductive device comprises a plurality of protrusions formed by sand blasting method or spot formation method.

The electronic device further comprises a circuit unit electronically connected to the first element and the second element. The electronic device can be a scanner, a liquid crystal display or a multi-function peripheral (MFP).

The first end of the conductive device comprises a smooth surface, and the second element further contacts the second end of the conductive device.

### DESCRIPTION OF THE DRAWINGS

The invention can be more fully understood by reading the subsequent detailed description and examples with references made to the accompanying drawings, wherein:

FIG. 1 is a schematic view of a conventional heat dissipation device disposed on a heat source;

FIG. 2 is a schematic view showing the conventional arrangement of exciting a light tube in a scanner;

FIG. 3 is a schematic perspective view of an electronic device (E) of a first embodiment of the invention;

FIG. 4A is a sectional view of the electronic device (E) along line (a-a) in FIG. 3;

FIG. 4B is an enlarged view of zone (z) of FIG. 4A;

FIG. 5 is a schematic perspective view of a conductive device (3′) of a second embodiment of the invention; and

FIG. 6 is an experimental curve diagram [lum(cd/m²−time(second)) of a heated lamp situated at different standby temperature.

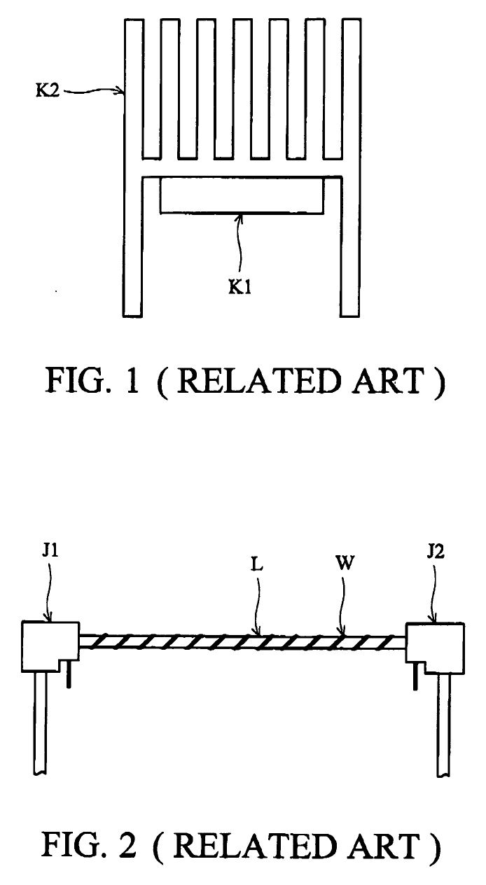

### DETAILED DESCRIPTION

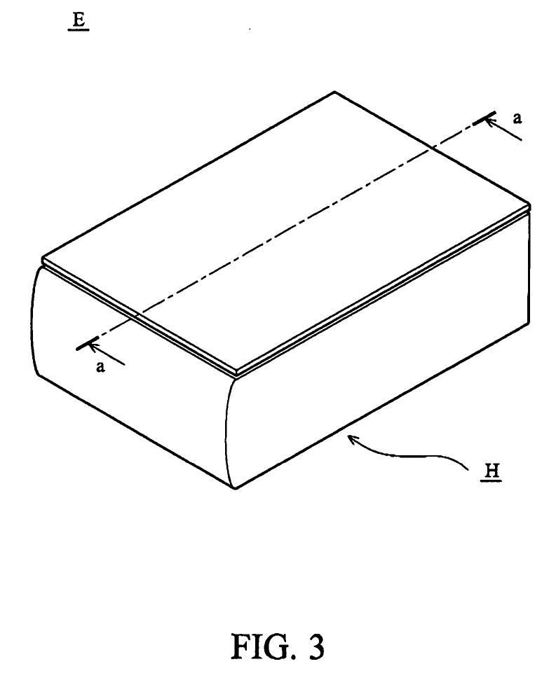

In FIG. 3, an electronic device E of the invention is a scanner. It is to be understood that the invention is not limited thereto the scanner, but, on the contrary, is intended to apply on the heated element or devices such as a liquid crystal display, a MFP (multi-function peripheral), etc.

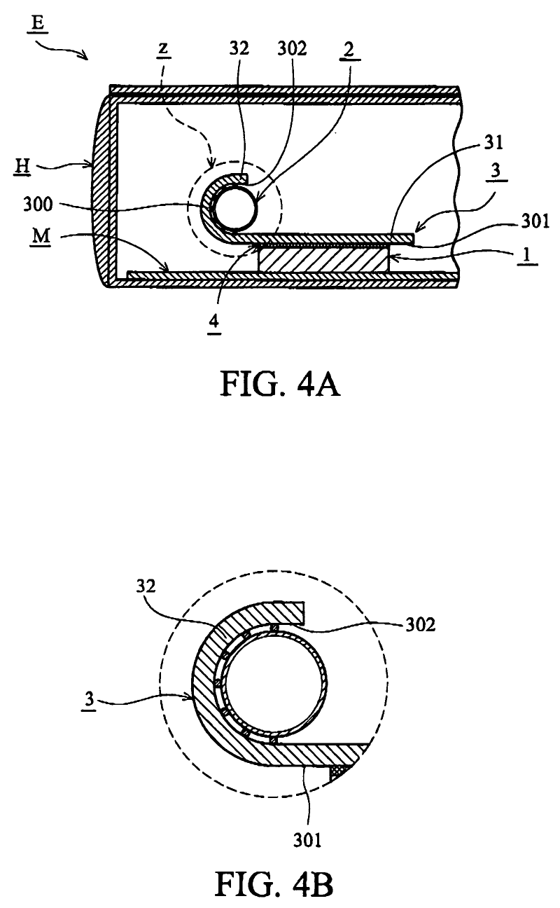

FIG. 4A is a sectional view of the scanner E along line a-a in FIG. 3, and FIG. 4B is an enlarged view of zone z of FIG. 4A.

The scanner E comprises a housing H, a first element 1, a second element 2, a conductive device 3, an intermediary 4 and a circuit unit M. The first element 1, the second element 2, the conductive device 3, the intermediary 4 and the circuit unit M are disposed in the housing H.

The circuit unit M electronically connected to the first element 1 and the second element 2, for example, is a motherboard disposed on the bottom of the housing H. In this embodiment, the first element 1 is a chip, e.g. CPU, disposed on the circuit unit M and generating a first temperature T1 during the operating process. The second element 2 which requires warm-up before the formal operation, in this embodiment, is a cold-cathode fluorescent lamp (abbreviated hereafter as CCFL), disposed on the circuit unit M.

The conductive device 3 is a metallic J-shaped plate such as copper or aluminum disposed between the first element 1 and the lamp 2 in this embodiment. The conductive device 3 comprises a flat portion 31 having a first end 301 and a curved portion 32 having a second end 302. The first end 301 of the conductive device 3 is a smooth surface used for conducting the first temperature T1.

The second end 302 of the curved portion 32 is formed with a plurality of protrusions 300. With the protrusions 300, an actual area of the curved portion 32 is increased. In this embodiment, the protrusions 300 are formed by sand blasting, spot formation method or other surface processing technologies.

The chip 1 is disposed on the first end 301 of the conductive device 3. The CCFL 2 disposed around to the second end 302 of the conductive device 3 is switchable between a standby mode and an operation mode.

In FIG. 4A, the chip 1 is disposed on the flat portion 31 of the conductive device 3, and an intermediary 4 such as cooling paste is further disposed between the first element 1 and the conductive device 3, so as to well transmit the first temperature T1 is from the intermediary 4 to the conductive device 3. The CCFL 2 is partially covered by the curved portion 32 of the conductive device 3 and the protrusions 300 of the curved portion 32 contact the lamp 2, so that the heat 25 dissipation area of the conductive device 3 can be increased.

When the first temperature T1 is transmitted from the first end 301 of the conductive device 3 to the second end 302 of the conductive device 3, the period for warm-up (i.e., from the standby mode to the operation mode) can be shortened. That is to say, due to the first temperature T1 from the chip 1 is transmitted to the CCFL 2 via the intermediary 4 and the conductive device 3, the CCFL 2 is heated and substantially kept at a thermal level, which shorten the warm-up period.

Furthermore, heat from the chip 1 expelled by the conductive device 3 can increase efficiency of the chip 1, shorten the warm-up time of the CCFL 2 and further reduce the time for the CCFL 2 to achieve a stable brightness. Also, manufacturing cost can be decreased without an additional device to heat the CCFL 2.

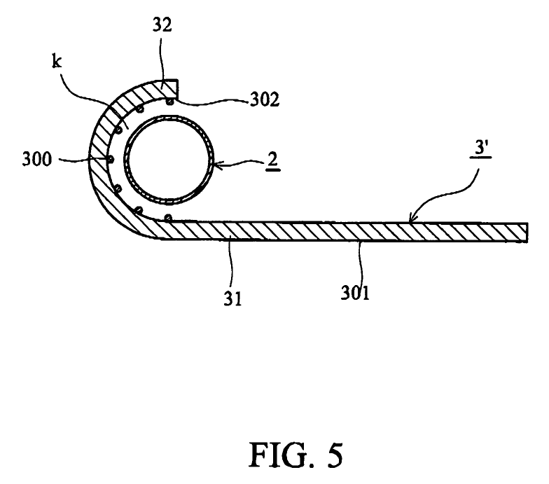

In FIG. 5, a conductive device 3′ of the second embodiment differs from the conductive device 3 in that the CCFL 2 is kept at a predetermined distance k with respect to the conductive device 3′, i.e., the CCFL 2 is disposed around to the second end 302 of the curved portion 32. With the protrusions 300 formed on the second end 302 of the curved portion 32, a heat dissipation area of the curved portion 32 is increased. In this embodiment, the protrusions 300 are formed by sand blasting, spot formation method or other surface processing technologies.

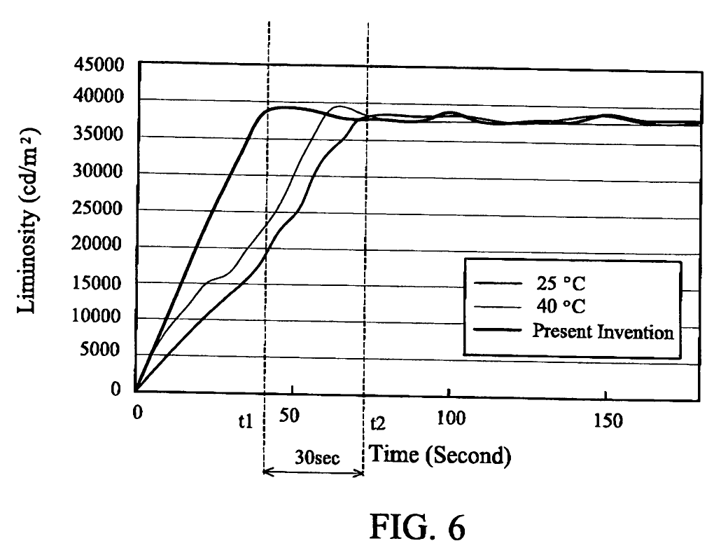

FIG. 6 shows the warm-up time between the standby mode to the operation mode when the heated CCFL situated at two different standby temperatures (25° C./40° C.).

The operation mode of the CCFL is set as 38,000 lum. When a CCFL is under standby temperature of 25° C. and 40° C., the required warm-up time are about 70 and 55 seconds, respectively. The warm-up time can be reduced under a higher standby temperature.

Under the invention, the warm-up time of the CCFL with aforementioned features set at room temperature (25° C.) is about 40 seconds. The warm-up time is reduced without an additional heating device.

While the invention has been described with respect to preferred embodiments, it is to be understood that the invention is not limited thereto the disclosed embodiments, but, on the contrary, is intended to accommodate various modifications and equivalent arrangements included within the spirit and scope of the appended claims.

What is claimed is:

1. An electronic device, comprising:
a conductive device comprising a first end and a second end;
a first element disposed on the first end of the conductive device, generating a first temperature; and
a second element disposed around to the second end of the conductive device, being switched from a standby mode to an operation mode, wherein the first temperature is transmitted from the first end of the conductive device to the second end of the conductive device to shorten a period from the standby mode to the operation mode.

2. The electronic device as claimed in claim 1, wherein the first element comprises a chip.

3. The electronic device as claimed in claim 1, wherein the second element comprises a light tube.

4. The electronic device as claimed in claim 1, wherein the second element comprises a cold-cathode fluorescent lamp.

5. The electronic device as claimed in claim 1, wherein the conductive device comprises a thermal conductive material.

6. The electronic device as claimed in claim 1 further comprises an intermediary disposed between the first element and the conductive device.

7. The electronic device as claimed in claim 6, wherein the intermediary comprises a cooling paste.

8. The electronic device as claimed in claim 6, wherein the intermediary comprises a dissipation fin.

9. The electronic device as claimed in claim 1, wherein the second end of the conductive device comprises a plurality of protrusions.

10. The electronic device as claimed in claim 9, wherein the protrusions are formed by sand blasting method.

11. The electronic device as claimed in claim 9, wherein the protrusions are formed by spot formation method.

12. The electronic device as claimed in claim 1 further comprising a circuit unit electronically connected to the first element and the second element.

13. The electronic device as claimed in claim 4, wherein the electronic device is a scanner.

14. The electronic device as claimed in claim 4, wherein the electronic device is a liquid crystal display.

15. The electronic device as claimed in claim 1, wherein the first end of the conductive device comprises a smooth surface.

16. The electronic device as claimed in claim 1, wherein the second element contacts the second end of the conductive device.
